(19) United States
(12) Patent Application Publication
(10) Pub. No.: US 2025/0182991 A1
(43) Pub. Date: Jun. 5, 2025

(54) RELAY CONTACT WEAR REDUCTION FOR ELECTRIC VEHICLE SUPPLY EQUIPMENT

(71) Applicant: Ampure Charging Systems, Inc., Monrovia, CA (US)

(72) Inventors: Rudolf Haeussermann, Stockdorf (DE); Lovlesh Tandon, Stockdorf (DE); Robert Ruef, Stockdorf (DE)

(21) Appl. No.: 18/840,686

(22) PCT Filed: Feb. 24, 2023
(86) PCT No.: PCT/EP2023/054689

§ 371 Date: Aug. 22, 2024

Related U.S. Application Data
(60) Provisional application No. 63/313,288, filed on Feb. 24, 2022.

(51) Int. Cl. H01H 47/02; B60L 53/22

(52) U.S. Cl. CPC H01H 47/02; B60L 53/22

(57) ABSTRACT

An electronic power switching circuit comprising a primary circuit with two conducting rails having a first end and a second end, wherein the conducting rails at the first end are configured to be connected to the two phases of an external AC power supply and a secondary circuit with two conducting rails having a first end and a second end, wherein the conducting rails at the first end are connected to the conducting rails at the second end of the primary circuit via electromechanical relays and interposed between the conducting rails and the conducting rails, respectively, wherein said relays are electrically actuated via a control unit, where the control unit controls the switching of the relays depending on the zero crossing time of the load current and/or the power supply voltage.

### CROSS-REFERENCE TO RELATED APPLICATIONS

This application is a 35 U.S.C. § 371 National Stage Entry of International Application No. PCT/EP2023/054689 filed Feb. 24, 2023, which claims the priority benefit of U.S. Provisional Patent Application No. 63/313,288 filed Feb. 24, 2022, all of which are incorporated herein by reference in their entirety for all purposes.

### TECHNICAL FIELD

The present invention relates to an electronic power switching circuit using electromechanical relays for switching of an external AC power supply to an onboard charging unit for charging of a battery of an electric vehicle (EV). It may thus also be referred to as a circuit used in electric vehicle supply equipment (EVSE). In particular, this disclosure relates to a circuitry and associated methods aiming at the reduction of relay contact wear induced by arcing between the contacts during opening and/or closing of the relay contacts.

### BACKGROUND

To charge batteries of EVs, it is useful to use large electrical power to limit the charging time to a reasonable level. For this purpose, batteries of EVs are typically charged with a large AC voltage supply from the public grid. Due to the large voltage at play, special care has to be taken when connecting an external power source to the EV. For this purpose, there are specifically designed AC charging devices for electric vehicles that use electronically controlled electromechanical relays to automatically switch the large supply voltage to the onboard charging unit of the EV. In particular, electromagnetic relays with movable contacts and coils are frequently used. Here, the coils generate magnetic fields to attract the movable contacts and ensure contact between the contacts and a static relay contact.

By turning on an electromechanical relay which closes a circuit connected thereto, electrical power from a supply voltage source (e.g. from the grid) may be connected to a capacitive load of the circuit. Depending on the grid impedance, the magnitude of the input capacitance of the capacitive load as well as the present voltage difference, excessive inrush currents can occur during closing of the relay contacts, ultimately resulting in arcing between the respective contacts. Furthermore, arcing is also present during the turn off (opening) of a relay if the relay opening breaks a circuit with finite current flowing therein. The arcing between relay contacts during opening and closing events significantly increases wear of the contacts and therefore limits the lifetime of the relays. In particular, the arcing leads to loss of relay contact material. Various ways to address the lifetime requirements of electromechanical relays, which is reduced by arcing between relay contacts, have been proposed. First of all, the material choice for the relay contacts plays a major role and is therefore limited to materials showing a high contact welding resistance. Since this excludes materials with low contact resistance, increased temperatures at the relay contacts will be apparent. Moreover, such materials additionally need to be rather thick to ensure a sufficient number of switching cycles before the materials are exhausted. The necessity of special materials and their increased thickness increases the cost for the relays.

Further, arcing during opening of relays can be limited by introducing a large gap between the relay contacts together with a large opening speed. These requirements do however increase the required size of the relays.

In order to limit relay contact wear during closure of the relay, bouncing control is of high importance. However, bouncing control of a closing contact is generally difficult to achieve. For the particular case of electromagnetic relays, strong coils are necessary to achieve weak bouncing effects.

Inrush currents during closure of a relay can also be limited by additional circuitry such as precharge circuits (for example by using negative temperature coefficient (NTC) thermistors) or snubber circuits (for example implemented as an RC circuit element across the relay contacts). Both of these solutions however cause additional cost to the device.

### SUMMARY

It is an object of the present invention to provide an electronic power switching circuit to improve the lifetime of electromechanical relays in AC charging devices, in particular for switching electrical power to an onboard charging unit of an electric vehicle.

This object is solved by the features of claim 1. Further advantageous embodiments result from the dependent claims, the description and the figures.

Accordingly, an electronic power switching circuit for relay contact wear reduction of AC-charging devices is presented, comprising a primary circuit with two conducting rails having a first end and a second end, wherein the conducting rails at the first end are configured to be connected to the two phases of an external AC power supply and a secondary circuit with two conducting rails having a first end and a second end, wherein the conducting rails at the first end are connected to the conducting rails at the second end of the primary circuit via two electromechanical relays interposed between the conducting rails of the primary and secondary circuit, wherein said two relays are electrically actuated via a control unit. According to the present invention, the control unit controls the switching of the relays depending on the zero crossing time of the load current and/or the power supply voltage.

More particularly, the present disclosure refers to an electronic power switching circuit capable of reducing the arcing between relay contacts during opening and/or closing of the relays by timing the relay opening to match a zero crossing of the AC load current, while timing the relay closing to match a zero crossing of the supply voltage.

Specifically, the present disclosure utilizes a control unit to switch the electromechanical relays at the right time of the AC current and/or voltage cycles. In general, the switching of the electromechanical relays is electronically actuated. In a preferred embodiment, the electromechanical relays are closed via a current in a coil configured to close a relay contact via the magnetic field it generates. Accordingly, the relay is opened by cutting the current supply to the coil.

In a state where both relays are turned on (closed), the turn off (opening) time of either one of the electromagnetic relays has to match a zero crossing of the AC load current, since the absence of current in the circuit obviously suppresses any arcing between opening contacts. In particular, the opening of the relay should be timed at or slightly before a zero crossing of the load current, otherwise a full half wave of arcing will be apparent.

In a state, where one of the relays is turned on (closed), while the other is turned off (open), the turn on (closing) of an electromagnetic relay has to match a zero crossing of the AC supply voltage, since the absence of a finite voltage difference between the relay contacts avoids inrush currents. In particular, the closing of the relay should be timed at or very close to a zero crossing of the supply voltage, otherwise a full half wave of arcing will be apparent.

However, to avoid arcing when closing the relay, it is not necessary to be timed at or slightly before the zero crossing of the supply voltage as it is the case with regard to the zero crossing of the load current in the opening case. Rather it is sufficient to be timed closely around the zero crossing.

For the purpose of an accurate timing of the relay opening and closing, the electronic power switching circuit according to the invention features means of detecting the load current in the circuit (given the case of closed relays) and means of detecting the supply voltage (given the case one or both of the relays is open). In particular, the circuit includes a control unit for detection of the measured current and voltage signals and features different methods for determining the frequency and phase of the respective parameters. The frequency and phase information in the control unit is then used to calculate an appropriate time delay for the opening and closing of the relays. In general, this time delay is different for the opening and closing of a relay.

For opening of a relay, where the zero crossing of the load current has to be matched, the relay turn off delay t_{off} is determined from the period duration 7 of the load current and the relay opening time tₒₚₑₙ according to t_{off}=7−tₒₚₑₙ. The relay opening time tₒₚₑₙ refers to the time it takes for the movable relay contact to lose electrical contact after its electronic actuation has been cut off, by which the associated circuit is switched open. The relay turn off delay t_{off} is measured from a zero crossing of the load current cycle. At the time t_{off} expires, the relay opening is initiated and at the time the relay opening time tₒₚₑₙ expires the relay loses contact at a zero crossing of the load current cycle.

For closing of the relay, where the zero crossing of the supply voltage has to be matched, the relay turn on delay tₒₙ is determined from the period duration Tᵥ of the supply voltage and the relay closing time t_{close} according to tₒₙ=Tᵥ−t_{close}. The relay closing time t_{close} refers to the time it takes for the movable relay contact to ensure electrical contact after its electronic actuation has been initiated, by which the associated circuit is electrically closed. The relay turn on delay tₒₙ is measured from a zero crossing of the supply voltage cycle. At the time tₒₙ expires, the relay closing is initiated and at the time the relay closing time t_{close} expires the relay makes contact at a zero crossing of the supply voltage cycle.

The above described features and methods of the invention improve the lifetime requirements of electromechanical relays used for switching of electrical power in light of the prior art.

In particular, the power switching circuit and the associated methods avoid the necessity to use special and expensive relay contact materials with high contact welding resistance, thus reducing the cost of the device as well as avoiding large temperatures at the contacts.

Moreover, the disclosure avoids the necessity to include additional circuitry specifically designed to avoid inrush currents. The invention thus reduces the complexity of the device.

In a further aspect of the disclosure, it is also not necessary to increase the size of the device by either additional circuitry or large relays, which have been used to avoid arcing in the prior art.

### BRIEF DESCRIPTION OF THE DRAWINGS

The present disclosure will be more readily appreciated by reference to the following detailed description when being considered in connection with the accompanying drawings in which:

FIG. 1 is a schematic circuit diagram of the electronic power switching circuit.

FIG. 2A is a graphical illustration of the time dependence of the AC load current, particularly describing the relation between the relay turn off delay t_{off}, the load current period 7 and the relay opening time tₒₚₑₙ

FIG. 2B is a graphical illustration of the time dependence of the AC supply voltage, particularly describing the relation between the relay turn on delay tₒₙ, the supply voltage period Tᵥ and the relay closing time t_{close};

FIG. 3 is a graphical illustration of the time dependence of the AC load current and/or supply voltage, describing the determination of the zero crossing time via a timer and current sampling;

FIG. 4 is a graphical illustration of the supply voltage at selected points of the first and second detection circuits of the power switching circuit shown in FIG. 1; and

FIG. 5 is a graphical illustration of the time dependence of the supply voltage along with the corresponding load current in a state where on relay is closed while the other is still open, illustrating a tolerance and/or aging-induced mismatch of the relay closing and zero crossing of the supply voltage and the corresponding adjustment of the relay closing time t_{close} to compensate for the relay aging and/or tolerances.

### DETAILED DESCRIPTION

In the following, the invention will be explained in more detail with reference to the accompanying Figures. In the Figures, like elements are denoted by identical reference numerals and repeated description thereof may be omitted in order to avoid redundancies.

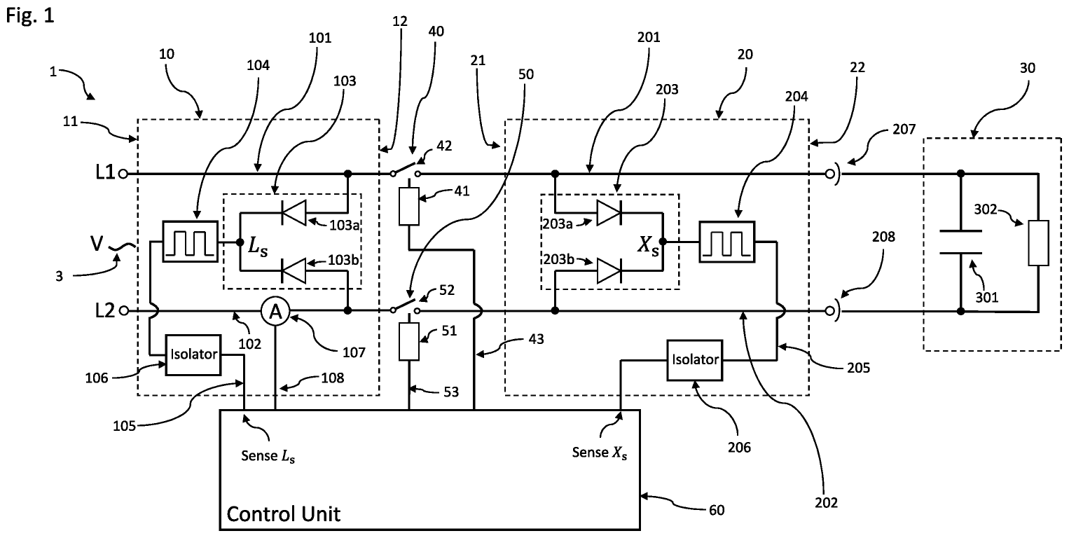

FIG. 1 shows one possible embodiment of a diagram for an electronic power switching circuit 1 used to reduce the contact wear of electromechanical relay switches in accordance with the current disclosure. The circuit 1 comprises a primary circuit 10 having two conducting rails 101, 102 with a first end 11 and a second end 12, wherein the first end 11 is connected to the two phases L1, L2 of an external AC power supply voltage 3. In the shown embodiment, the phases L1 and L2 refer to a split-phase electric power supply as commonly used in the US, where the two phases are typically provided by two 120 V lines (L1, L2), which are out of phase by 180 degrees with each other. Furthermore, the circuit 1 features a secondary circuit 20 having two conducting rails 201, 202 with a first end 21 and a second end 22, wherein the conducting rails 201, 202 at the position of their first end 21 are connected to the conducting rails 101, 102 of the primary circuit 10 at their second end 12 via electromechanical relays 40 and 50. Relay 40 is interposed between the conducting rails 101 and 201, while relay 50 is interposed between the conducting rails 201 and 202.

In a preferred embodiment, the electromechanical relay switches are implemented as normally open electromagnetic relays 40, 50 comprising movable contacts 41, 51 and coils 42, 52. A current in the coils can generate a magnetic field capable of closing the contacts so as to electrically connect the conducting rails 101, 102 of the primary circuit 10 with the conducting rails 201, 202 of the secondary circuit 20. The circuit 1 is electrically closed only when both relays 40, 50 are turned on via an external current in the coils 42, 52.

For an external, small signal control for the switching of the electromagnetic relays 40, 50, the circuit 1 features a control unit 60. The control unit 60 is connected via signal lines 43 and 53 to the coils 41 and 51 of the electromagnetic relays 40 and 50, respectively, so as to subject a current to the coils 41, 51 for switching of the electromagnetic relays 40, 50. In the depicted example, the electromagnetic relays 40, 50 are implemented as normally open contacts, i.e. the relays are turned off open when no current is applied to the coils 41, 51.

In a preferred embodiment, the control unit 60 may be implemented as a microcontroller. However, any other programmable control unit capable of electronically actuating electronic components such as electromechanical relays as well as detecting and processing time dependent voltage or current data is suitable and falls within the framework of the invention.

The circuit 1 as disclosed herein, aiming at contact wear reduction of electromechanical relays, is not restricted to electromechanical relays in the form of electromagnetic relays featuring coils and movable contacts described above, but any other electrically controllable relay switch with a mechanical contacting mechanism may be used within the framework of the invention. Moreover, relays in a normally closed state might also be used in an alternative embodiment.

The second end 22 of the secondary circuit 20 features contacts 207, 208 connectable to an onboard charging unit 30 of an electric vehicle EV connected to a battery for charging of the EV. For the sake of simplicity, the onboard charging unit 30 is characterized by merely two components, namely an input capacitance 301 and a load resistance 302, the invention is however not limited to such simplistic configuration of the onboard charging unit 30. Each of the two sub-circuits, i.e. the primary circuit 10 and secondary circuit 20 feature a detection circuit for measuring the frequency and phase of the AC supply voltage provided by the two phases L1 and L2.

In the embodiment shown in FIG. 1, the detection circuits of the primary 10 and secondary 20 circuit comprise full-wave rectifiers 103 and 203, each of which are implemented as two parallelly connected diodes 103a, 104b and 203a, 204b, respectively. The diodes 103a and 103b are connected to the conducting rails 101 and 102 of the primary circuit 10, while the diodes 203a and 203b are connected to the conducting rails 201 and 202 of the secondary circuit, respectively. It should be noted that the invention is not restricted to this particular type of voltage rectification, but any other means of voltage rectification, for example using a full bridge rectifier, is suitable.

The conducting paths associated with the two diodes 103a and 103b of the primary circuit 10 as well as to the two diodes 203a and 203b of the secondary circuit 20 merge in a point Lₛ and Xₛ, respectively. Thereafter, the rectified voltage at points Lₛ and Xₛ may be led into pulse generators 104 and 204, respectively, creating digital pulses as soon as the rectified voltage signals exceed a certain level. These pulses are then transmitted via isolators 106, 206 along the signal lines 105 and 205 to the control unit 60.

The isolators 106 and 206 interposed within the signal lines 105 and 205, respectively, act as a way of electrically decoupling the detection circuit from the main power circuit and are necessary for the measurement of the voltage pulses without disturbing the main power circuit, as well as for safety reasons. Furthermore, the isolators may be utilized for down-transforming the voltage signals so as to create appropriate voltage levels for being measured in the control unit 60.

In a preferred embodiment, the isolators 106, 206 might be implemented as optical couplers or pulse transformers. The invention is however not restricted to these types of isolation means, but any other type of insulation suitable for decoupling the detection circuit from the main power circuit so as to measure the voltage pulses is possible.

In the course of this disclosure, we will differentiate between the detection circuits enclosed by the primary 10 and secondary circuits 20 described above and a main power switching circuit. The latter is characterized by the conducting rails 101, 102, 201, 202, the electromechanical relays 40, 50 and the onboard charging unit 30 to which the conducting rails 201, 202 are connected to at contacts 207 and 208. In other words, the main power switching circuit refers to the part of the circuit 1 in which the load current is supposed to flow. Hence, the load current is defined as the current flowing in the conducting rails 101, 102, 201, 202 when the two electromagnetic relays 40, 50 are turned on closed, such that a charging current can flow across the onboard charging unit 30.

For the purpose of measuring the load current of the circuit 1, the primary circuit 10 features a current sensor 107 interposed within the conducting rail 102. For detection of the load current, the current sensor 107 is connected to the control unit 60 via a signal line 108.

It is noted that the invention is not restricted to a particular placement of the current sensor 107 within the primary circuit 10, but any other position within the conducting rails 101, 102, 201, 204 is suitable for measuring the load current via the current sensor 107.

In the following, the requirements and methods for turning off and turning on of the electromechanical relays with the purpose of reduced arcing between opening and closing relay contacts are described based on the electronic power switching circuit 1, which allows for a proper timing of the relay switching so as to reduce contact wear of the relays.

### Turn Off Case

First, the case of turning off the relay switches is considered. Hence, the relay switches 40, 50 are initially in a turned on closed state, such that the primary 10 and secondary circuit 20 are connected to each other via the relays, allowing for a finite load current to flow in the circuit so as to supply the onboard charging unit 30 with charging current.

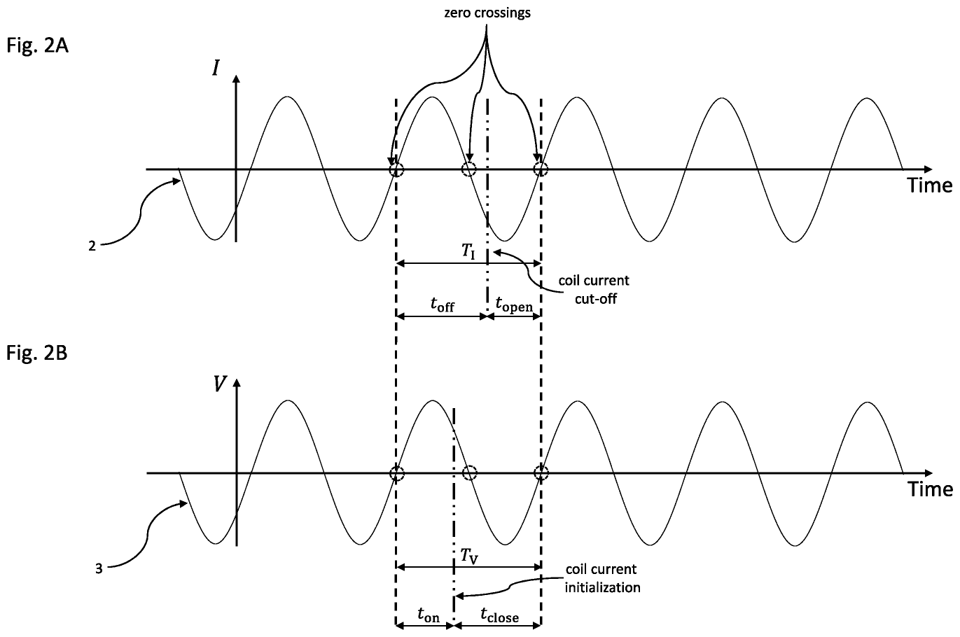

In such state, a finite AC load current I flows as shown in FIG. 2A. Hence, the opening for turning off of either one of the relays leads to arcing between the respective contacts of the relay, resulting in increased wear of the contacts. Significant reduction of arcing during the opening of a relay can be achieved when the opening time is chosen close to a zero crossing of the load current cycle 2. In particular, the opening time should be chosen either at or slightly before the zero crossing time, otherwise a full half-wave of arcing is the consequence.

In order to determine a proper timing for the relay opening, the frequency and phase of the load current 2 has to be measured. In one possible embodiment, the current sensor 106 detects the zero crossings of the load current and the control unit 60 uses this event as a trigger. The consecutive trigger events for each zero crossing allow for the determination of the frequency and phase of the load current 2, from which the associated time period 7 can be easily deduced. Then, the required turn off delay t_{off}, i.e. the time delay between a zero crossing of the load current and the coil current cut-off time of the associated relay coil 41, 51 is calculated according to t_{off}=7−tₒₚₑₙ, where tₒₚₑₙ is the relay opening time, i.e. the time it takes for the relay to lose contact after the coil current is cut-off by the control unit 60. Eventually, a timer in the control unit 60 is used to trigger the cut-off of current from the relay coil 41, 51 with a time delay t_{off} after the detection of a zero crossing in the load current 2.

A major drawback of the procedure explained above is that the detection of the zero crossing of the load current requires a large sampling rate/sample of the control unit 60 so as to achieve an accurate determination of the zero crossing. For this purpose, [symbol] At has to be fulfilled, where/sample

[symbol]

At corresponds to the maximum tolerable timing error with regard to the detection of the zero crossing time. For a somewhat accurate determination of the latter, the timing error should be at least smaller than an eighth of the time period of the load current cycle, making the required sample rate sample at least eight times larger than the frequency of the load current. Such large sampling rate may require rather large computing capacity and may thus interfere with other tasks of the control unit 60. Moreover, since the current signal may be noisy, several periods may be necessary to find the zero crossings, which may violate the maximum turn off time specifications of the device.

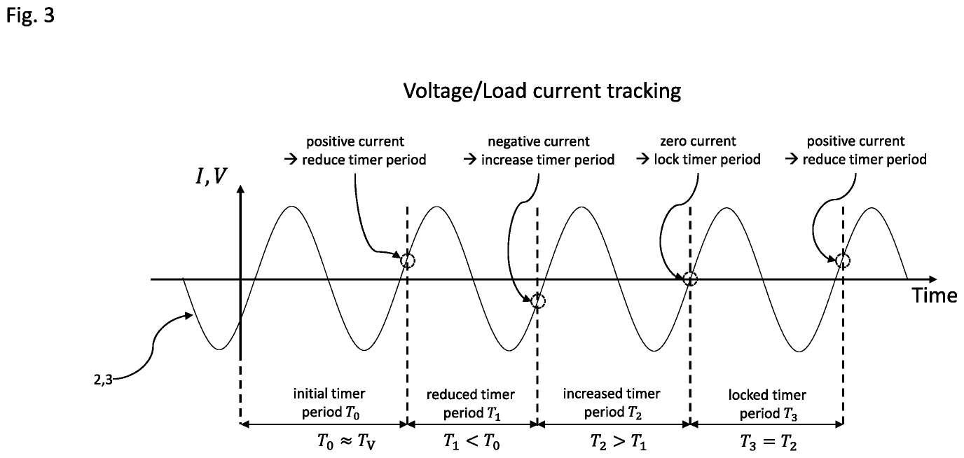

This may be improved by another possible method according to the invention, which is based on keeping track of the load current frequency and phase during operation of the device. The associated method is illustrated graphically in FIG. 3. First, a periodic timer from the control unit 60 is set to a period To corresponding to the approximate period duration Tᵥ of the external supply voltage. Every time the timer expires, the current sensor 107 samples the present current value. Depending on the sampled current magnitude and polarity, the timer period is increased/decreased if the sampled current is positive/negative. This procedure continues until the timer locks on the zero crossings of the load current. Eventually, the frequency and phase of the load current can be deduced from the locked internal timer of the control unit 60. The respective turn off delay time t_{off} is calculated in accordance with the procedure described in the foregoing paragraph. Accordingly, the relay is turned off i.e. the coil current is cut off with a time delay t_{off} with respect to the locked timer rate. Using this method, the required sample rate sample for measuring the current is greatly reduced by at least a factor of 8 compared to the method described in the foregoing paragraph, since the current is only sampled with a rate corresponding to the approximate frequency of the supply voltage.

In a state, where both relays are turned on closed, the turn off of the relay switches preferably takes place successively. Hence, after determining the turn-off delay time t_{off} according to the above described methods, either one of the electromechanical relays 40 or 50 is turned off with the appropriate timing described before. After completion of the first turn off of one of the relays, the second relay can be turned off at any time since no finite load current can flow after the opening of the first relay switch, thus suppressing any arcing.

Since the risk of arcing between the relay contacts in the turn off case is only apparent for the first relay to be turned off, the order of the turn off of the two relays 40 and 50 is preferably reversed on each turn off switching cycle, so as to balance the remaining contact wear of the two relays.

### Turn on Case

Subsequently, the case of turning on the relay switches 40, 50 is considered. Hence, a state in which the relay switches are initially turned off opened is considered, such that the primary 10 and secondary circuit 20 are disconnected, preventing load current to flow in the main power circuit.

In such state, the turn on closing of one relay 40 or 50 does not lead to arcing between the respective contacts of the relays since no current can flow yet. The closing of the second relay, however, might lead to arcing if the contact closing time corresponds to a finite voltage in the AC supply voltage cycle. This inrush current due to the closing contact generally depends on the grid impedance related to the external supply voltage, the input capacitance 301 of the onboard charging unit 30 and the absolute voltage difference present at the time of closing the second relay contact. Significant reduction of arcing during the closing of the second relay can thus be most conveniently achieved when the closing time is chosen close to a zero crossing of the supply voltage cycle. In particular, the closing time should be chosen either at or in close proximity to the zero crossing time, otherwise a full half-wave of arcing is the consequence.

As described with regard to FIG. 1, the power switching circuit 1 comprises two detection circuits for voltage measurement, which are enclosed in the primary 10 and secondary circuit 20, respectively. Both detection circuits can be used to determine the frequency and phase of the supply voltage so as to command a proper timing of the relay closing time.

In a state, where both relays are turned off, voltage can only be detected in the first detection circuit of the primary circuit 10, since both phases L1 and L2 are disconnected from the second detection circuit of the secondary circuit 20.

In accordance with the embodiment of the electronic power switching circuit 1 shown in FIG. 1, the determination of the frequency and phase of the supply voltage can be performed rather conveniently via voltage rectification in the full-wave rectifiers 103, 203 together with the subsequent pulse generation in the pulse generators 104, 204. The pulse generators 104, 204 transform the rectified voltage stemming from the full-wave rectifiers 103, 203 into digital pulses that can be detected in the control unit 60.

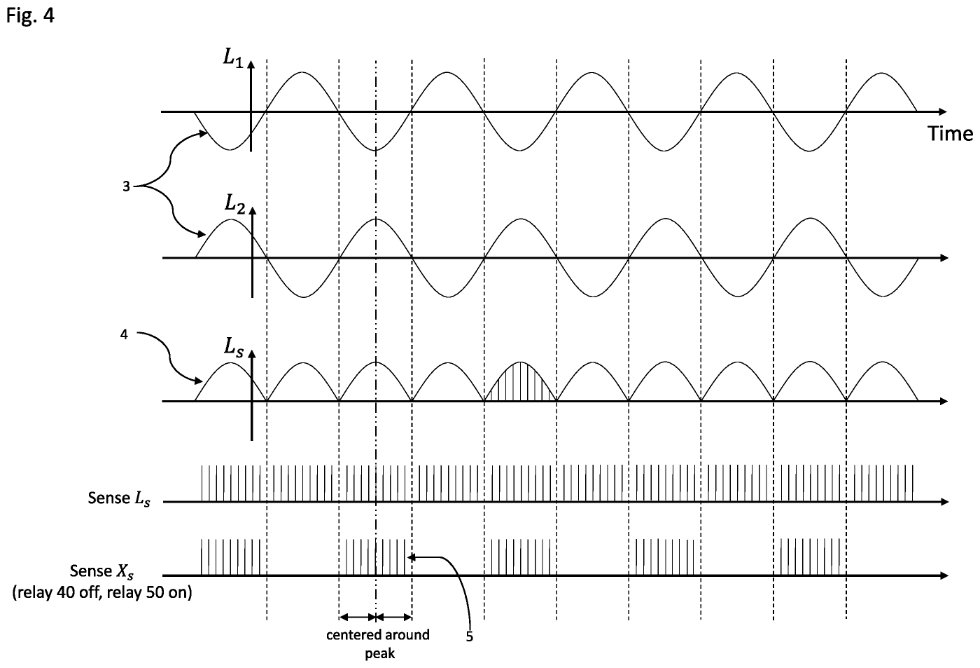

A graphical illustration of the procedure for measuring frequency and phase of the supply voltage using voltage pulses generated therefrom is shown in FIG. 4. Here, first the analog supply voltage signals 3 stemming from the two phases L1 and L2 are shown as a function of time. Further, the rectified voltage 4 after the full-wave rectifier 103 at point Lₛ in the first detection circuit of the primary circuit 10 is shown. The rectified voltage 4 can be fed into the pulse generator 104 and can be sensed as pulses in the control unit 60. Pulses are generated when the rectified supply voltage reaches a certain threshold value, leading to pulse packets 5 for each half-wave of the original supply voltage. Upon determining the center of each pulse packet 5, the frequency and phase of the supply voltage can be deduced. Accordingly, the first detection circuit can be used to detect the supply voltage characteristics in a state where both of the relays are turned off open.

It should be noted, however, that in the above considered state, where both relays are turned off, the determination of the frequency and phase of the supply voltage is very inaccurate, since the distance between each of the pulse packets 5 is rather short, making their separation challenging. Hence, in the considered state, the first detection circuit may be mostly used to merely detect the presence of the supply voltage.

For a more accurate determination of the frequency and phase of the supply voltage, it is advisable to only consider pulse packets 5 of one of the phases L1 or L2, since the temporal distance between the pulse packets 5 becomes larger and thus it will also be easier to determine the center of the individual pulse packets 5. This can be realized by turning on only one of the relays 40 or 50. Accordingly, pulses will be generated in the second detection circuit of the secondary circuit 20 for either the half-waves corresponding to phase L1 or the half-waves corresponding to L2, depending on whether relay 40 or 50 has been turned on closed, respectively. In FIG. 4, the pulse packets 5 corresponding to phase L2 detected in the second detection circuit are shown for the case when relay 40 is open, while relay 50 is closed. Accordingly, pulse packets 5 appear only for the positive half-waves of phase L2. Upon determining the center of each pulse packet 5, the frequency and phase of the supply voltage can be deduced. Accordingly, the second detection circuit can be used to detect the supply voltage characteristics in a state where only one of the relays is closed.

Preferably, the turn on sequence of the relays is implemented as follows. First, one of the relays 40 or 50 is turned on closed by supplying current from the control unit 60 to the respective coil 41 or 51, leading to no arcing yet as the circuit is still open due to the other opened relay. Thereafter, the frequency and phase of the supply voltage is determined using the pulse packets 5 detected in the control unit 60 stemming from the second detection circuit of the secondary circuit 20. Due to only one relay being closed, the resulting pulse packets 5 only appear for one half-wave of either phase L1 if relay 40 is closed or phase L2 if relay 50 is closed, allowing for an accurate determination of the frequency and phase, from which the supply voltage period Tᵥ can be deduced. Accordingly, the turn on delay time tₒₙ can be determined as tₒₙ=Tᵥ−t_{close}, where t_{close} is the relay closing time, i.e. the time it takes for the relay to ensure contact after the coil current is initialized. Eventually, a timer in the control unit 60 is used to initialize the coil current for the relay coil with a time delay tₒₙ after a zero crossing of the supply voltage. Note, that the zero crossing of the supply voltage can be deduced from the determination of the center of the pulse packets 5, since both frequency and phase are known therefrom.

In an alternative embodiment, the first detection circuit of the primary circuit 10 and/or the second detection circuit of the secondary circuit 20 might also lack the pulse generators 104, 204 and fullwave rectifiers 103, 203 and may thus be implemented such that the unprocessed voltage signals from the supply voltage are detected as analog signals in the control unit 60. In this case, the frequency and phase of the supply voltage 3 can be measured with the same methods as described for the frequency and phase determination of the load current 2.

Accordingly, in order to determine a proper timing for the relay closing without processing pulses from the supply voltage 3 for detection, the frequency and phase of the supply voltage 3 can be measured similarly to the load current 2. In one possible embodiment, the microcontroller detects the zero crossing of the supply voltage and the control unit 60 uses this event as a trigger. The consecutive trigger events for each zero crossing allow for the determination of the frequency and phase of the supply voltage 3, from which the associated time period Tᵥ can be easily deduced. Then, the required turn on delay tₒₙ, i.e. the time delay between a zero crossing of the supply voltage 3 and the initialization time of the coil current of the associated relay coil is calculated according to tₒₙ=Tᵥ−t_{close}. Eventually, a timer in the control unit 60 is used to initialize the coil current for the respective relay coil with a time delay tₒₙ after the detection of a zero crossing in the supply voltage 3.

In accordance with the case described for the detection of zero crossings in the load current 2, the detection of zero crossings in the supply voltage 3 as described in the foregoing paragraph also requires a large sampling rate of the control unit 60 that may interfere with other tasks of the control unit 60. According to the invention, this may be improved by a method that is based on keeping track of the supply voltage frequency and phase during operation of the device, equivalent to the case of load current detection. The associated method is illustrated graphically in FIG. 3. First, a periodic timer from the control unit 60 is set to a period To corresponding to the approximate period duration Tᵥ of the external supply voltage 3. Every time the timer expires, the control unit 60 samples the present voltage value. Depending on the sampled voltage magnitude and polarity, the timer period is increased/decreased when the sampled voltage is positive/negative. This procedure continues until the timer locks on the zero crossings of the supply voltage. Eventually, the frequency and phase of the supply voltage can be deduced from the locked internal timer of the control unit 60. The respective turn on delay time tₒₙ is calculated in accordance with the procedure described in the foregoing paragraph.

Unlike the turn off opening time tₒₚₑₙ, the relay turn on time t_{close} is temperature dependent due to the temperature-induced resistance change of the coils 41, 51. The coil current rise time/slope in the coil is therefore also temperature dependent, thus leading to a temperature dependence of fciose- The invention offers different methods to compensate for this additional complexity.

In one embodiment, the temperature-induced change of t_{close} may be compensated by software means. In particular, the control unit 60 might use a temperature dependent relay turn on delay tₒₙ, e.g. implemented as a mathematical function or a Look-Up-Table. Depending on the prevalent temperature of the coils 41, 51, the relay turn on delay tₒₙ is thus changed accordingly.

An alternative approach may be to directly measure and control the relay coil current to the desired rise time/slope so as to tune the associated closing time t_{close} to a constant value independent of the temperature. In particular, this allows fine-tuning of the relay closing time t_{close} by detecting the movement of the movable contacts 42, 52 of the relays 40, 50.

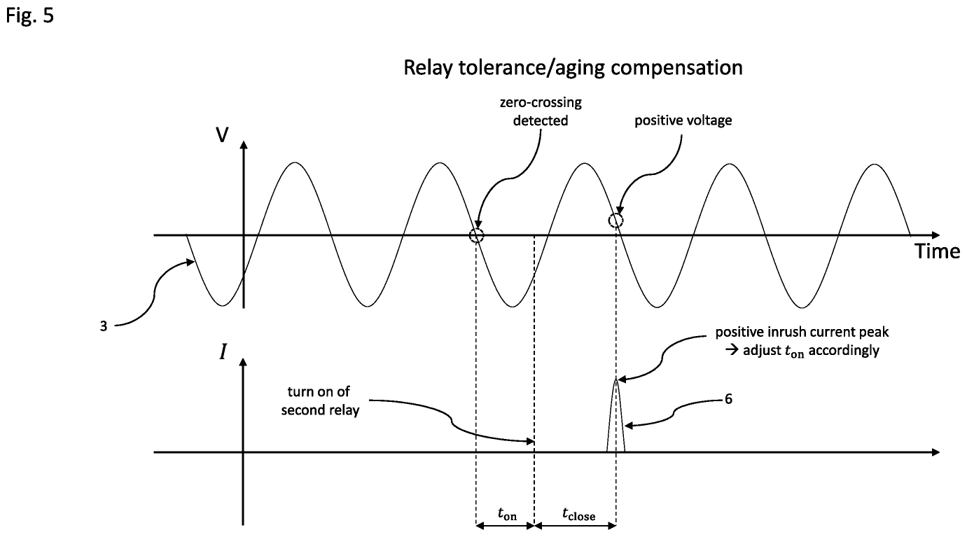

A further feature of the invention with regard to the turn on of relays relates to tolerance and/or aging compensation of the relay closing time t_{close}, as illustrated in FIG. 5. Since the relay closing time t_{close} may be subject to changes due to aging or tolerances caused by manufacturing, the present invention offers means of compensation for these changes. In a state, where one of the relays 40, 50 is closed, while the other is still open, the closing of the second relay may lead to a finite inrush current 6 in case the closing time does not exactly match the zero crossing of the supply voltage 3. According to the invention, such inrush current can be measured by the current sensor 107 and detected in the control unit 60. The magnitude and polarity of the detected inrush current 6 can be used to correct the relay closing time t_{close} so as to rematch with the zero crossing of the associated supply voltage 3.

Accordingly, in the case depicted in FIG. 5 and in a state, where one of the relays 40, 50 is closed, while the other is still open, and the closing of the second relay leads to a finite positive inrush current 6 due to a positive supply voltage 3 at the time of the closing, the relay closing time tdose of the second relay is adjusted by increasing it in proportion to the measured magnitude of the inrush current 6. In the case of a negative inrush current due to a negative voltage signal at the time of the closing of the relay contacts, the relay closing time t_{close} is decreased accordingly. In the case where the detected zero crossing of the supply voltage, from which the relay turn on delay time tₒₙ is measured and after which the relay turn on is initialized, is shifted by half a period of the supply voltage as compared to the case depicted in FIG. 5, the relay closing time t_{close} has to be increased when a negative inrush current due to a negative supply voltage at the time of the relay contact closing is measured, but decreased when a positive inrush current is measured. It will be obvious for a person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention.

### LIST OF REFERENCE NUMERALS

I electronic power switching circuit
10 primary circuit
II first end of primary circuit
12 second end of primary circuit
101 first conducting rail of primary circuit
102 second conducting rail of primary circuit
103 first full-wave rectifier
103a first diode of first full-wave rectifier
103b second diode of first full-wave rectifier
104 first pulse generator
105 signal line of first detection circuit of the primary circuit
106 first isolator
107 current sensor
108 signal line of current sensor
20 secondary circuit
21 first end of secondary circuit
22 second end of secondary circuit
201 first conducting rail of secondary circuit
202 second conducting rail of secondary circuit
203 second full-wave rectifier
203a first diode of second full-wave rectifier
203b second diode of second full-wave rectifier
204 second pulse generator
205 signal line of first detection circuit of the secondary circuit
206 second isolator
207 first contact of second end of secondary circuit
208 second contact of second end of secondary circuit
30 onboard charging unit
301 input capacitance
302 load resistance
40 first electromechanical relay
41 coil of first electromechanical relay
42 movable latch of first electromechanical relay
43 signal line of coil of first electromechanical relay 50 second electromechanical relay
51 coil of second electromechanical relay
52 movable latch of second electromechanical relay
53 signal line of coil of second electromechanical relay 60 control unit
2 load current
3 supply voltage
4 rectified voltage at point Lₛ
5 pulse packet 6 inrush current peak

1. An electronic power switching circuit for relay contact wear reduction of AC-charging devices, comprising:
a primary circuit with first and second conducting rails having a first end and a second end, wherein the first and second conducting rails at the first end are configured to be connected to the two phases of an external AC power supply, and
a secondary circuit with third and fourth conducting rails having a first end and a second end, wherein the third and fourth conducting rails at the first end are connected to the first and second conducting rails at the second end of the primary circuit via electromechanical relays interposed between the first and third conducting rails and the second and fourth conducting rails, respectively, wherein
said relays are electrically actuated via a control unit,
wherein the control unit controls the switching of the relays depending on a zero crossing time of at least one of: a load current and a power supply voltage.

2. The electronic power switching circuit according to claim 1, wherein at least one of: the primary circuit comprises a first detection circuit and the secondary circuit comprises a second detection circuit for measuring a frequency and phase of the power supply voltage.

3. The electronic power switching circuit according to claim 2, wherein the first detection circuit and/or second detection circuit comprise a first and second fullwave rectifier to rectify an AC supply voltage, a first and second pulse generator to generate digital pulses from the rectified voltage, a first and second isolator for electrical decoupling of the first and/or second detection circuit and a first and second signal line connected to the control unit for transmission and detection of the voltage pulses.

4. The electronic power switching circuit according to claim 3, wherein the first and second full-wave rectifiers are implemented as two parallelly connected diodes, respectively.

5. The electronic power switching circuit according to claim 3, wherein the first and second isolator are implemented as at least one of: an optical coupler and pulse transformer.

6. The electronic power switching circuit according to claim 1, wherein the primary and secondary circuit comprises a current sensor connected to the control unit via a signal line, which is integrated into the first and second conducting rails of the primary and the third and fourth conducting rails of the secondary circuit for measuring and detecting the load current.

7. The electronic power switching circuit according to claim 1, wherein the second end of the secondary circuit may be connected to an onboard charging unit for charging of a battery of an electric vehicle.

8. The electronic power switching circuit according to claim 7, wherein the onboard charging unit for charging of a battery of an electric vehicle is mainly characterized by an input capacitance and a load resistance.

9. The electronic power switching circuit according to claim 1, wherein the relay switches are electromagnetic relays comprising movable contacts and coils, which are connected to the control unit via a first signal line and a second signal line to control the switching of the relays.

10. The electronic power switching circuit according to claim 1, wherein in a state where both relays are turned on, one of the relays is turned off as close as possible to the zero crossing time of the load current, but always before the zero crossing.

11. A method for a turn off sequence of two relay switches, wherein in a state where both relays switches are turned on,
determining, by a current sensor and a control unit, the period and phase of a load current, and
calculating the relay turn off delay time t_{off} based on the time period 7 of the load current and the relay opening time tₒₚₑₙ according to t_{off}=7−tₒₚₑₙ, and
commanding the turn off of either one of the relays switches via the control unit based on the turn off delay time t_{off} such that a first relay switch or a second relay switch of the two relay switches loses contact at or slightly before the zero crossing time of the load current, and the yet turned on relay is turned off after the first one has been turned off, wherein the turn off order of the two relays is reversed on each power switching cycle.

12. The electronic power switching circuit according to claim 1, wherein in a state where one of the relays is turned off while the other is turned on, the turn on of the yet turned off relay is performed as close as possible to the zero crossing time of the supply voltage.

13. The electronic power switching circuit according to claim 12, wherein in a state where one of the relays (40) or (50) is turned off while the other is turned on, the control unit (60) compensates for the temperature dependent relay closing time t_{close} when turning on the yet turned off relay.

14. The electronic power switching circuit according to claim 13, wherein the compensation for the temperature dependent relay closing time t_{close} via the control unit is implemented by at least one of: measuring the coil temperature und using a temperature-dependent relay turn on delay tₒₙ and via measuring and controlling the coil current rise time and thus tuning the closing time t_{close} appropriately.

15. The electronic power switching circuit according to claim 12, wherein in a state where one of the relays is turned on while the other is turned off and the turn on of the second relay leads to a finite inrush current due to a mismatch of the closing contact time and the zero crossing time of the supply voltage, the polarity and magnitude of the finite inrush current is used to correct the relay closing time t_{close} to account for tolerances and drift over time of the individual relay.

16. A method for a turn on sequence of two relay switches, wherein in a state where both relays are turned off,
determining, by a first detection circuit of a primary circuit, a period and phase of a supply voltage,
turning on a first relay switch or a second relay switch of the two relay switches is turned on,
determining, by a first and second detection circuit enclosed in a primary and secondary circuit, respectively, a period and phase of a supply voltage,
calculating, the relay turn on delay time tₒₙ, based on the time period Tᵥ of the supply voltage (3) and the relay close time t_{close} according to tₒₙ=Tᵥ−t_{close}, and
commanding the turn on of the yet turned off first relay switch or second relay switch, via a control unit based on a turn on delay time tₒₙ such that the yet turned off relay is turned on at or in close proximity to the zero crossing time of the supply voltage, wherein the turn on order of the two relays switches is reversed for each power switching cycle.

17. The electronic power switching circuit according to claim 1, wherein the control unit is a microcontroller.
